(19) United States
(12) Patent Application Publication
(10) Pub. No.: US 2013/0194380 A1
(43) Pub. Date: Aug. 1, 2013

(54) IMAGE PROCESSING APPARATUS AND METHOD

(71) Applicant: Samsung Electro-Mechanics Co., Ltd., Gyeonggi-do (KR)

(72) Inventors: Hae Jin Jeon, Gyeonggi-do (KR); In Taek Song, Gyeonggi-do (KR)

(73) Assignee: SAMSUNG ELECTRO-MECHANICS CO., LTD., Gyeonggi-do (KR)

(21) Appl. No.: 13/744,165

(22) Filed: Jan. 17, 2013

(30) Foreign Application Priority Data
Jan. 18, 2012 (KR) 10-2012-0005477

(51) Int. Cl. H04N 5/232

(52) U.S. Cl. CPC H04N 5/23238
USPC 348/36

(57) ABSTRACT

Disclosed herein are an image processing apparatus and method. The image processing apparatus synthesizing images collected from n camera modules disposed in each direction with each other to generate an omni-directional image, includes: n position sensors each included in each of the camera modules to detect a current position coordinate value of a corresponding camera module; and an image processing unit determining whether an inclined camera module is present using the current position coordinate values of each of the camera modules detected by the position sensor and correcting a position value of an image obtained by the inclined camera module in the case in which the inclined camera module is present, thereby generating the omni-direction image. Therefore, a distortion-free omni-directional image may be generated without performing an arithmetic process according to a complicated algorithm.

### CROSS REFERENCE(S) TO RELATED APPLICATIONS

This application claims the benefit under 35 U.S.C. Section 119 of Korean Patent Application Serial No. 10-2012-0005477, entitled “Image Processing Apparatus AND Method” filed on Jan. 18, 2012, which is hereby incorporated by reference in its entirety into this application.

### BACKGROUND OF THE INVENTION

1. Technical Field

The present invention relates to an image processing apparatus and method, and more particularly, to an image processing apparatus and method generating a distortion-free omni-directional image around a vehicle using a position sensor.

2. Description of the Related Art

Recently, a vehicle is mounted with various electronic systems for providing convenience and safety to a driver and a passenger.

Particularly, a vehicle image system accepting surrounding environment and providing safety and convenience to the driver using various sensors has been developed. This vehicle image system has a camera, or the like, mounted in the vehicle to utilize an image around the vehicle, thereby increasing safety in the driver's driving and assisting in recognizing an object to decrease a collision accident.

As one of the vehicle image systems, a rear image system is generally well-known. The rear image system includes a camera provided to the rear of the vehicle to photograph a rear image and displays the photographed image through a display device such as a liquid crystal display (LCD), or the like, located at a position at which it is comfortable for the driver to view, for example, at an upper end of a front panel. Therefore, the driver needs not to twist his/her body to see the rear in order to confirm a rear object at the time of backward movement of the vehicle.

However, as a significantly advanced system, a vehicle omni-directional image system photographing a 360-degree image around a vehicle through camera modules mounted on the front and rear and the left and right of the vehicle and providing the photographed image to a driver has been recently proposed. This system has firstly been mounted in the vehicle model Infinity by Nissan of Japan and has currently been used in a number of completed vehicles.

A general vehicle image system may include a camera module including a lens receiving a camera image, an image sensor, and the like, a micro control unit (MCU) controlling the image sensor, an image processing unit processing an image obtained by the camera module according to a predetermined algorithm, an amplifier (AMP) amplifying an image output of the image sensor, and the like.

In this configuration, wide angle lenses capable of securing a visual field of 180 degrees or more instead of a general lens are used in the camera modules, and these camera modules are provided in the front and rear and the left and right of the vehicle, that is, four directions, thereby building a vehicle omni-directional image system capable of sensing an omni-directional image around the vehicle.

As described above, in order to implement the vehicle omni-directional image system, images obtained by at least four camera modules should be synthesized. In this synthesizing process, complicated arithmetic is performed by a number of image processing algorithms. The omni-directional vehicle image system according to the related art performs these algorithms on the assumption that the vehicle is positioned on a flat floor.

FIGS. 1A to 1C are views showing an image output in the case in which a camera module is inclined in a vehicle omni-directional image system according to the related art.

Referring to FIG. 1A, it may be appreciated that in the case in which a front camera is inclined, images are synthesized with each other in a state in which an image in a section (a) corresponding to a front image section of a vehicle is inclined, such that a discontinuous omni-directional image is output.

In addition, as shown in FIG. 1B, when a side camera is inclined, it can be appreciated that a section (b), which is a side image section of the vehicle is synthesized while it is inclined to output a discontinuous omni-directional image.

In addition, as shown in FIG. 1C, when a side camera is inclined, it can be appreciated that a section (c), which is a side image section of the vehicle is synthesized while it is inclined to output a discontinuous omni-directional image.

As described above, in the case in which a mounting position of the camera is deviated or the vehicle is inclined due to an increase in passengers in the vehicle in the vehicle omni-directional image system according to the related art, arithmetic by an image synthesizing algorithm performed in the image processing unit is significantly changed, such that a synthesizing region section is deviated, thereby displaying a discontinuous omni-direction image.

Meanwhile, in order to solve this problem, an arithmetic process of measuring and correcting an inclined degree of the camera module is included in the image synthesizing algorithm itself performed in the image processing unit. However, as described above, at least four images should be synthesized with each other in order to implement the omni-directional image. When the arithmetic process measuring the inclined degree of the camera module is included in this synthesizing algorithm, a calculation amount in the image processing unit is more complicated and multiplexed, such that it is difficult to smoothly perform the image processing.

### SUMMARY OF THE INVENTION

An object of the present invention is to provide an image processing apparatus and method in which a position sensor is provided in each camera module to measure an inclined angle of a camera module, thereby accurately implementing an omni-directional image without performing arithmetic processing by a complicated algorithm.

According to an exemplary embodiment of the present invention, there is provided an image processing apparatus synthesizing images collected from n camera modules disposed in each direction with each other to generate an omni-directional image, the image processing apparatus including: n position sensors each included in each of the camera modules to detect a current position coordinate value of a corresponding camera module; and an image processing unit determining whether an inclined camera module is present using the current position coordinate values of each of the camera modules detected by the position sensor and correcting a position value of an image obtained by the inclined camera module in the case in which the inclined camera module is present, thereby generating the omni-direction image.

Each of the camera modules may further include a lens receiving light reflected from a subject; an image sensor converting the light received in the lens into an electrical image sensor; and a communication interface communicating with the image processing unit.

The image processing unit may include a determining unit comparing a preset reference coordinate value and the current position coordinate value detected by the position sensor with each other to determine whether each of the camera modules is inclined; a measuring unit calculating a difference between the preset reference coordinate value and the current position coordinate value detected by the position sensor to measure an inclined angle of the inclined camera module; a correcting unit calculating a correction value corresponding to the inclined angle and reflecting the calculated correction value in the position value of the image obtained by the inclined camera module to correct the position value; and an image synthesizing unit synthesizing the images collected from each of the camera modules with each other to generate the omni-directional image.

The image processing apparatus may further include an encoder encoding an image signal received from the camera module; and a decoder processing the omni-directional image generated in the image processing unit so as to be displayed.

The image processing unit may further include a storing unit storing the reference coordinate values of each of the camera modules therein.

N may be four, and the camera modules may be disposed in front and rear and left and right directions.

The measuring unit may calculate the difference between the preset reference coordinate value and the current position coordinate value detected by the position sensor to measure an angle (θx) at which a y-z plane is inclined based on an x axis, an angle (θy) at which an x-z plane is inclined based on a y axis, and an angle (θz) at which an x-y plane is inclined based on a z axis.

In the correcting unit, correction values (x′, y′, and z′) may be calculated according to the following Equation 1 in the case in which the inclined angle of the camera module measured by the measuring unit is θx:

$$[ \begin{matrix}{x}^{′} \\ {y}^{′} \\ {z}^{′}\end{matrix} ] = [ \begin{matrix}1 & 0 & 0 \\ 0 & cos θ & sin θ \\ 0 & - sin θ & cos θ\end{matrix} ] [ \begin{matrix}x \\ y \\ z\end{matrix} ] , \qquad [ Equation 1 ]$$

correction values (x′, y′ and z′) may be calculated according to the following Equation 2 in the case in which the inclined angle of the camera module measured by the measuring unit is θy:

$$[ \begin{matrix}{x}^{′} \\ {y}^{′} \\ {z}^{′}\end{matrix} ] = [ \begin{matrix}sin θ & 0 & cos θ \\ 0 & 1 & 0 \\ cos θ & 0 & - sin θ\end{matrix} ] [ \begin{matrix}x \\ y \\ z\end{matrix} ] , \qquad [ Equation 2 ]$$

correction values (x′, y′, and z′) may be calculated according to the following Equation 3 in the case in which the inclined angle of the camera module measured by the measuring unit is θz:

$$[ \begin{matrix}{x}^{′} \\ {y}^{′} \\ {z}^{′} \end{matrix} ] = [ \begin{matrix}cos θ & sin θ & 0 \\ - sin θ & cos θ & 0 \\ 0 & 0 & 1\end{matrix} ] [ \begin{matrix}x \\ y \\ z\end{matrix} ] , \qquad [ Equation 3 ]$$

and

the position value of the image obtained by the inclined camera module may be moved by the calculated correction values (x′, y′, and z′).

According to an exemplary embodiment of the present invention, there is provided an image processing method performed using an image processing apparatus including n camera modules each including a lens, an image sensor, a position sensor, and a communication interface, and an image processing unit including a determining unit, a measuring unit, a correcting unit, and an image synthesizing unit, the image processing method including: (a) converting, in the image sensor, light received through the lens into an electrical image signal; (b) detecting, in the position sensor included in each of the camera modules, a current position coordinate value of a corresponding camera module; (c) comparing, in the determining unit, a preset reference coordinate value and the current position coordinate value detected by the position sensor with each other to determine whether each of the camera modules is inclined; (d) calculating, in the measuring unit, a difference between the reference coordinate value of the inclined camera module and the current position coordinate value detected by the position sensor to measure an inclined angle, in the case in which it is determined that the camera module is inclined; (e) calculating, in the correcting unit, a correction value corresponding to the inclined angle and reflecting the calculated correction value in a position value of an image obtained by the inclined camera module to correct the position value; and (f) synthesizing, in the image synthesizing unit, images collected from each of the camera modules with each other to generate an omni-directional image.

In the case in which it is determined in step (c) that the camera module is not inclined, an image obtained by the camera module that is not inclined may be transmitted to the image synthesizing unit.

Step (d) may be performed by calculating the difference between the preset reference coordinate value and the current position coordinate value detected by the position sensor to measure an angle (θx) at which a y-z plane is inclined based on an x axis, an angle (θy) at which an x-z plane is inclined based on a y axis, and an angle (θz) at which an x-y plane is inclined based on a z axis.

In step (e), correction values (x′, y′ and z′) may be calculated according to the following Equation 1 in the case in which the inclined angle of the camera module measured by step (d) is θx:

$$[ \begin{matrix}{x}^{′} \\ {y}^{′} \\ {z}^{′}\end{matrix} ] = [ \begin{matrix}1 & 0 & 0 \\ 0 & cos θ & sin θ \\ 0 & - sin θ & cos θ\end{matrix} ] [ \begin{matrix}x \\ y \\ z\end{matrix} ] \qquad [ Equation 1 ]$$

correction values (x′, y′ and z′) may be calculated according to the following Equation 2, in the case in which the inclined angle of the camera module measured by the measuring unit is θy:

$$[ \begin{matrix}{x}^{′} \\ {y}^{′} \\ {z}^{′}\end{matrix} ] = [ \begin{matrix}sin θ & 0 & cos θ \\ 0 & 1 & 0 \\ cos θ & 0 & - sin θ\end{matrix} ] [ \begin{matrix}x \\ y \\ z\end{matrix} ] \qquad [ Equation 2 ]$$

correction values (x′, y′ and z′) may be calculated according to the following Equation 3 in the case in which the inclined angle of the camera module measured by the measuring unit is θz:

$$[ \begin{matrix}{x}^{′} \\ {y}^{′} \\ {z}^{′ }\end{matrix} ] = [ \begin{matrix}cos θ & sin θ & 0 \\ - sin θ & cos θ & 0 \\ 0 & 0 & 1\end{matrix} ] [ \begin{matrix}x \\ y \\ z\end{matrix} ] , \qquad [ Equation 3 ]$$

and

the position value of the image obtained by the inclined camera module may be moved by the calculated correction values (x′, y′ and z′).

The image processing method may further include processing the omni-directional image generated in step (f) through the decoder so as to be displayed.

### BRIEF DESCRIPTION OF THE DRAWINGS

FIGS. 1A, 1B, and 1C are views showing images outputted when a camera module is inclined in a vehicle omni-directional image system according to the related art;

FIG. 2 is a block diagram showing a schematic configuration of an image processing apparatus according to an exemplary embodiment of the present invention; and

FIG. 3 is a flowchart sequentially showing an image processing method using the image processing apparatus according to the exemplary embodiment of the present invention.

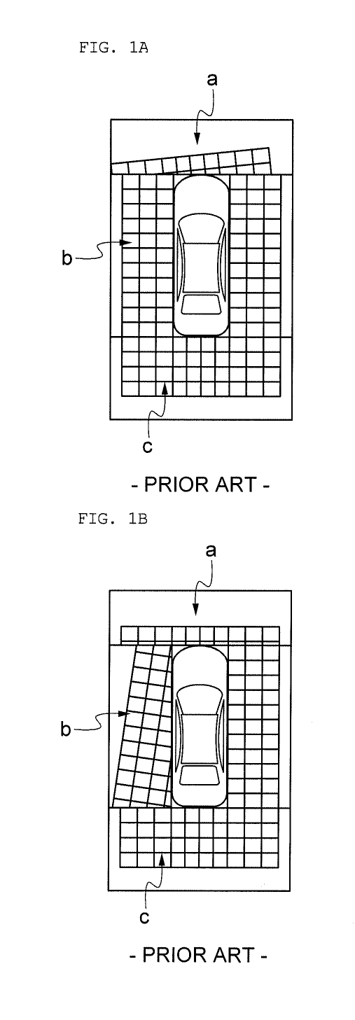

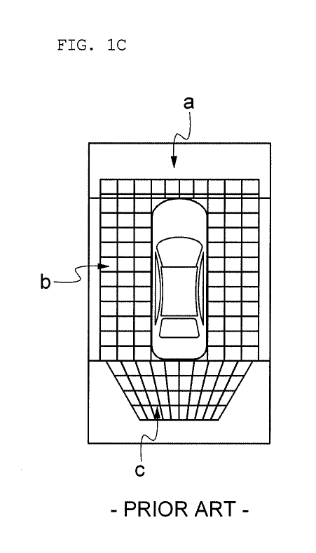

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

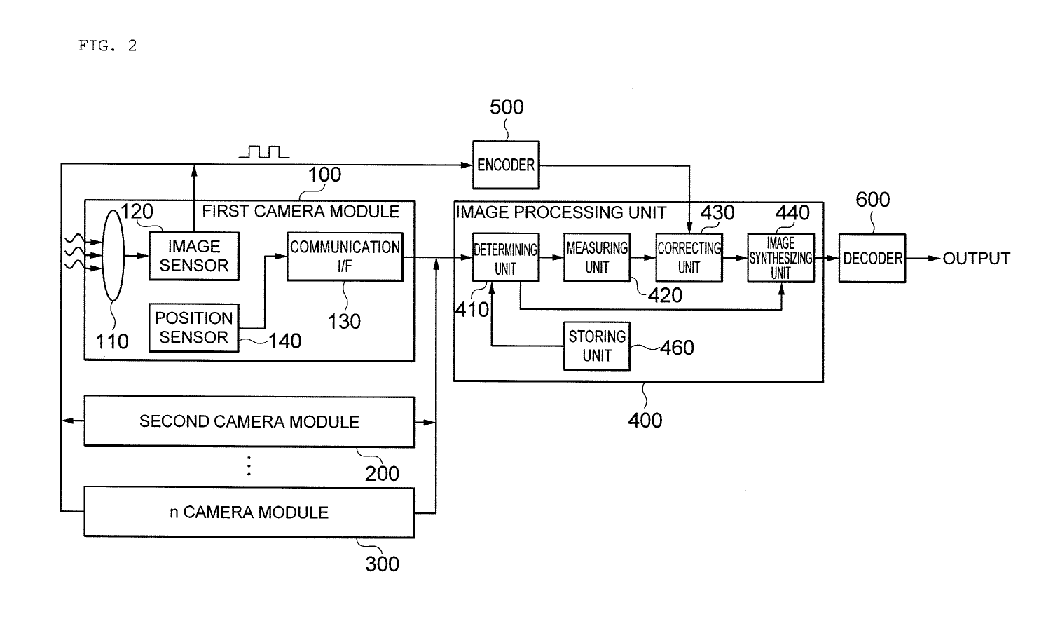

FIG. 2 is a block diagram showing a schematic configuration of an image processing apparatus according to an exemplary embodiment of the present invention.

Referring to FIG. 2, the image processing apparatus according to the exemplary embodiment of the present invention includes n camera modules 100, 200, and 300 and an image processing unit 400.

Each of the n camera modules 100, 200, and 300 may be disposed in each direction. Since the image processing apparatus according to the exemplary embodiment of the present invention may be applied to a vehicle omni-directional image system generating an omni-directional image around a vehicle to provide the omni-directional image to a driver, the number of n camera modules 100, 200, and 300 may be generally four. Therefore, each of the four camera modules may be disposed toward the front, the rear, the left, and the right of the vehicle.

Each of the camera modules 100, 200, and 300 may include a lens 110 receiving light reflected from a subject, an image sensor 120 converting the light received in the lens 110 into an electrical image signal, and a communication interface 130 communicating with the image processing unit 400. Although only the lens 110, the image sensor 120, and the communication interface 130 included in a first camera module 100 are shown in FIG. 2 for simplification, it is obvious that each of a second camera module 200 and n camera module 300 includes a lens, an image sensor, and a communication interface, similar to the first camera module 100.

In addition, a position sensor 140 may be provided in each of the camera modules 100, 200, and 300. This position sensor 140 serves to convert a point at which a camera module is positioned into a three-dimensional coordinate value to detect a position coordinate value at which the camera module is currently positioned.

Therefore, in the case in which the number of camera modules is four (that is, n is 4), the number of position sensors 140 may be also four. Each of these four position sensors may be provided in the camera modules to calculate current position coordinate values for each of the four camera modules.

The current position coordinate values for each of the camera modules 100, 200, and 300 calculated as described above is transmitted to the image processing unit 400 through the communication interface 130 and used to determine whether or not each of the camera modules 100, 200, and 300 is inclined or to measure an inclined angle of the each of the camera modules 100, 200, and 300, or the like.

The image processing unit 400 may determine whether an inclined camera module is present using the current position coordinate values of each of the camera modules 100, 200, and 300 detected by the position sensor 140 and correct a position value of an image obtained by the inclined camera module in the case in which the inclined camera module is present, thereby generating an omni-directional image.

A configuration of the image processing unit 400 will be described in more detail. The image processing unit 400 may include a determining unit 410 determining whether the camera module is inclined, a measuring unit 420 measuring an inclined angle of the camera module, a correcting unit 430 correcting a position value of an inclined image, and an image synthesizing unit 440 generating an omni-directional image.

The determining unit 410 may determine whether or not the each of the camera modules 100, 200, and 300 is inclined by comparing a preset reference coordinate value and a current position coordinate value detected by the position sensor 140 with each other.

For example, in the case in which the number of camera modules is four (that is, n is 4), a reference coordinate value of a first camera module is set to (10, 10, 15), and it is determined that the first camera module is inclined when a current position coordinate value detected by a position sensor included in the first camera module is different from the reference coordinate value (10, 10, 15). In this scheme, whether or not second to fourth camera modules are inclined may be determined.

In order to perform this determination, the image processing unit 400 may further include a storing unit 450 storing preset reference coordinate values of each of the camera modules 100, 200 and 300 therein.

The measuring unit 420 may measure the inclined angle of the inclined camera module by calculating a difference between the preset reference coordinate value and the current position coordinate value detected by the position sensor 140.

Specifically, the inclined angle may be measured as an angle (θx) at which a y-z plane is inclined based on an x axis, an angle (θy) at which an x-z plane is inclined based on a y axis, and an angle (θz) at which an x-y plane is inclined based on a z axis by calculating the difference between the preset reference coordinate value and the current position coordinate value detected by the position sensor 140. In other words, a position of an image of x, y and z axes changed due to external influence may be corrected by changed position data θ.

This correction process will be described in detail together with an algorithm performed in the correcting unit 430.

The correcting unit 430 may calculate a correction value corresponding to the inclined angle measured by the measuring unit 420 and reflect the calculated correction value in the position value of the image obtained by the inclined camera module to correct the image obtained by the inclined camera module.

This correction process will be described in more detail. For example, in the case in which an inclined angle of the camera module measured by the measuring unit 420 is θx, a correction value is calculated according to the following Equation 1:

$$[ \begin{matrix}{x}^{′} \\ {y}^{′} \\ {z}^{′}\end{matrix} ] = [ \begin{matrix}1 & 0 & 0 \\ 0 & cos θ & sin θ \\ 0 & - sin θ & cos θ\end{matrix} ] [ \begin{matrix}x \\ y \\ z\end{matrix} ] \qquad [ Equation 1 ]$$

in the case in which an inclined angle of the camera module measured by the measuring unit 420 is θy, a correction value is calculated according to the following Equation 2:

$$[ \begin{matrix}{x}^{′} \\ {y}^{′} \\ {z}^{′}\end{matrix} ] = [ \begin{matrix}sin θ & 0 & cos θ \\ 0 & 1 & 0 \\ cos θ & 0 & - sin θ\end{matrix} ] [ \begin{matrix}x \\ y \\ z\end{matrix} ] , \qquad [ Equation 2 ]$$

and

in the case in which an inclined angle of the camera module measured by the measuring unit 420 is θz, a correction value is calculated according to the following Equation 3:

$$[ \begin{matrix}{x}^{′} \\ {y}^{′} \\ {z}^{′ }\end{matrix} ] = [ \begin{matrix}cos θ & sin θ & 0 \\ - sin θ & cos θ & 0 \\ 0 & 0 & 1\end{matrix} ] [ \begin{matrix}x \\ y \\ z\end{matrix} ] . \qquad [ Equation 3 ]$$

Where (x, y, z) is a current position coordinate value of the camera module detected by the position sensor 140, and (x′, y′, z′) is a calculated correction value.

When the correction value is calculated as described above, a position value of the image obtained by the inclined camera module is moved by the correction value to thereby be corrected.

The image synthesizing unit 440 may synthesize the images collected from each of the camera modules 100, 200, and 300 with each other with reference to the position values of each image to generate an omni-directional image.

Meanwhile, the image processing apparatus according to the exemplary embodiment of the present invention may further include an encoder 500 and a decoder 600.

An image signal converted in the image sensor 120 included in the camera module is outputted to the encoder 500, and the encoder 500 converts (encodes) the image signal into a digital signal appropriate for image processing to transmit the digital signal to the correcting unit 430.

The decoder 600 may decode the omni-directional image generated in the image synthesizing unit 440 so as to be displayed to allow the driver to recognize the omni-directional image around the vehicle.

Hereinafter, an image processing method using the image processing apparatus according to the exemplary embodiment of the present invention will be described.

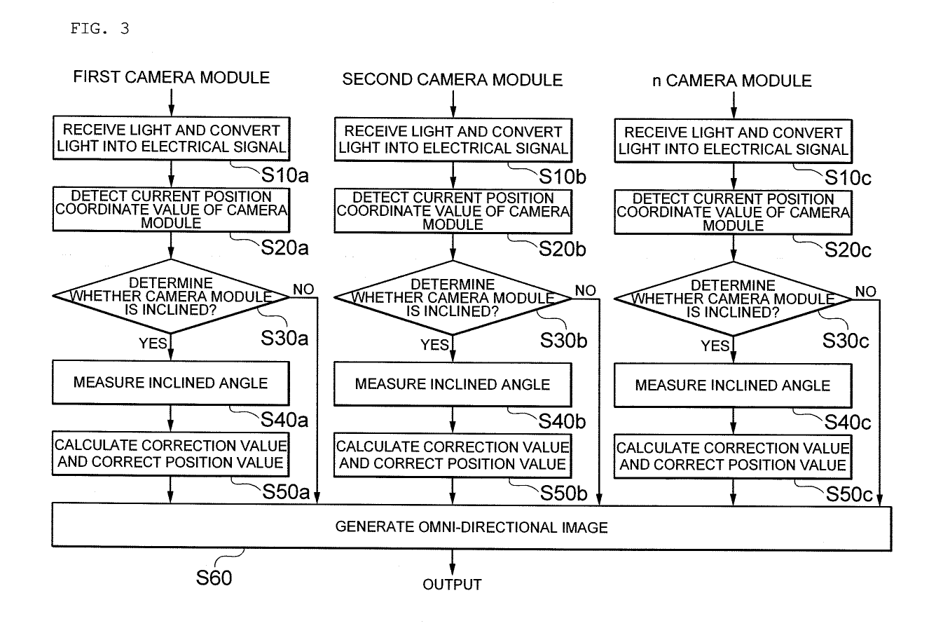

FIG. 3 is a flowchart sequentially showing an image processing method using the image processing apparatus according to the exemplary embodiment of the present invention.

Referring to FIG. 3, in the image processing method, the image processing apparatus including n camera modules 100, 200, and 300 each including a lens 110, an image sensor 120, a position sensor 140, and a communication interface 130, and an image processing unit 400 including a determining unit 410, a measuring unit 420, a correcting unit 430, and an image synthesizing unit 440 is used. First, operations of converting light received through the lens 110 into an electrical image sensor may be performed in the image sensor 120 for each camera module (S10a, S10b, and S10c).

Then, operations of detecting a current position coordinate value of a corresponding camera module may be performed in the position sensor 140 included in each of the camera modules 100, 200, and 300 (S20a, S20b, and S20c).

Next, operations of comparing a preset reference coordinate value and the current position coordinate value detected by the position sensor 140 with each other to determine whether each of the camera modules 100, 200, and 300 is inclined may be performed (S30a, S30b, and S30c).

Since a specific method of determining whether the camera module is inclined has previously been described, a detailed description thereof will be omitted.

In addition, when it is determined in the operations S30a, S30b and S30c that the camera module is inclined, operations of calculating a difference between the reference coordinate value of the corresponding camera module and the current position coordinate value detected by the position sensor 140 to measure an inclined angle may be performed (S40a, S40b, and S40c).

Otherwise, that is, when it is determined in the operations S30a, S30b and S30c that the camera module is not inclined, the image obtained by the corresponding camera module may be transmitted to the image synthesizing unit 440.

When the inclined angle is measured in the operations S40a, S40b, and S40c, operations of calculating a correction value corresponding to the inclined angle and reflecting the calculated correction value in the position value of the image obtained by the inclined camera module to correct the position value of the image may be performed in the correcting unit 430 (S50a, S50b, and S50c).

Since a specific method for correction has previously been described, a detailed description thereof will be omitted.

Then, an operation of receiving the position value of the image corrected in the operations S50a, S50b, and S50c or the position value of the image obtained by the camera module determined in the operations S30a, S30b, and S30c not to be inclined, from each of the camera modules 100, 200, and 300, and referring to this, synthesizing the images collected from each of camera modules 100, 200, and 300 with each other with reference to the position value to generate an omni-directional image (S60) may be performed in the image synthesizing unit 440.

Meanwhile, in the image processing method using the image processing apparatus according to the exemplary embodiment of the present invention, an operation of processing the omni-directional image generated in the operation S60 through the decoder 600 so as to be displayed may be further performed.

As set forth above, with the image processing apparatus and method according to the exemplary embodiments of the present invention, each of the camera modules includes the position sensor, and the position values of the images obtained by the camera modules are adjusted using the position sensor, thereby making it possible to generate a distortion-free omni-directional image without performing an arithmetic process according to a complicated algorithm.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An image processing apparatus synthesizing images collected from n camera modules disposed in each direction with each other to generate an omni-directional image, the image processing apparatus comprising:
n position sensors each included in each of the camera modules to detect a current position coordinate value of a corresponding camera module; and
an image processing unit determining whether an inclined camera module is present using the current position coordinate values of each of the camera modules detected by the position sensor and correcting a position value of an image obtained by the inclined camera module in the case in which the inclined camera module is present, thereby generating the omni-direction image.

2. The image processing apparatus according to claim 1, wherein each of the camera modules further includes:
a lens receiving light reflected from a subject;
an image sensor converting the light received in the lens into an electrical image sensor; and
a communication interface communicating with the image processing unit.

3. The image processing apparatus according to claim 1, wherein the image processing unit includes:
a determining unit comparing a preset reference coordinate value and the current position coordinate value detected by the position sensor with each other to determine whether each of the camera modules is inclined;
a measuring unit calculating a difference between the preset reference coordinate value and the current position coordinate value detected by the position sensor to measure an inclined angle of the inclined camera module;
a correcting unit calculating a correction value corresponding to the inclined angle and reflecting the calculated correction value in the position value of the image obtained by the inclined camera module to correct the position value; and
an image synthesizing unit synthesizing the images collected from each of the camera modules with each other to generate the omni-directional image.

4. The image processing apparatus according to claim 1, further comprising:
an encoder encoding an image signal received from the camera module; and
a decoder processing the omni-directional image generated in the image processing unit so as to be displayed.

5. The image processing apparatus according to claim 3, wherein the image processing unit further includes a storing unit storing the reference coordinate values of each of the camera modules therein.

6. The image processing apparatus according to claim 1, wherein n is four, and
the camera modules are disposed in front and rear and left and right directions.

7. The image processing apparatus according to claim 3, wherein the measuring unit calculates the difference between the preset reference coordinate value and the current position coordinate value detected by the position sensor to measure an angle (θx) at which a y-z plane is inclined based on an x axis, an angle (θy) at which an x-z plane is inclined based on a y axis, and an angle (θz) at which an x-y plane is inclined based on a z axis.

8. The image processing apparatus according to claim 7, wherein in the correcting unit, correction values (x′, y′, and z′) are calculated according to the following Equation 1 in the case in which the inclined angle of the camera module measured by the measuring unit is θx:
$$[ \begin{matrix}{x}^{′} \\ {y}^{′} \\ {z}^{′}\end{matrix} ] = [ \begin{matrix}1 & 0 & 0 \\ 0 & cos θ & sin θ \\ 0 & - sin θ & cos θ\end{matrix} ] [ \begin{matrix}x \\ y \\ z\end{matrix} ] , \qquad [ Equation 1 ]$$
correction values (x′, y′ and z′) are calculated according to the following Equation 2 in the case in which the inclined angle of the camera module measured by the measuring unit is θy:
$$[ \begin{matrix}{x}^{′} \\ {y}^{′} \\ {z}^{′}\end{matrix} ] = [ \begin{matrix}sin θ & 0 & cos θ \\ 0 & 1 & 0 \\ cos θ & 0 & - sin θ\end{matrix} ] [ \begin{matrix}x \\ y \\ z\end{matrix} ] , \qquad [ Equation 2 ]$$
correction values (x′, y′, and z′) are calculated according to the following Equation 3 in the case in which the inclined angle of the camera module measured by the measuring unit is θz:
$$[ \begin{matrix}{x}^{′} \\ {y}^{′} \\ {z}^{′ }\end{matrix} ] = [ \begin{matrix}cos θ & sin θ & 0 \\ - sin θ & cos θ & 0 \\ 0 & 0 & 1\end{matrix} ] [ \begin{matrix}x \\ y \\ z\end{matrix} ] , \qquad [ Equation 3 ]$$
and
the position value of the image obtained by the inclined camera module is moved by the calculated correction values (x′, y′, and z′).

9. An image processing method performed using an image processing apparatus including n camera modules each including a lens, an image sensor, a position sensor, and a communication interface, and an image processing unit including a determining unit, a measuring unit, a correcting unit, and an image synthesizing unit, the image processing method comprising:
(a) converting,in the image sensor, light received through the lens into an electrical image signal;
(b) detecting,in the position sensor included in each of the camera modules, a current position coordinate value of a corresponding camera module;
(c) comparing, in the determining unit, a preset reference coordinate value and the current position coordinate value detected by the position sensor with each other to determine whether each of the camera modules is inclined;
(d) calculating, in the measuring unit, a difference between the reference coordinate value of the inclined camera module and the current position coordinate value detected by the position sensor to measure an inclined angle, in the case in which it is determined that the camera module is inclined;
(e) calculating, in the correcting unit, a correction value corresponding to the inclined angle and reflecting the calculated correction value in a position value of an image obtained by the inclined camera module to correct the position value; and
(f) synthesizing, in the image synthesizing unit, images collected from each of the camera modules with each other to generate an omni-directional image.

10. The image processing method according to claim 9, wherein in the case in which it is determined in step (c) that the camera module is not inclined, an image obtained by the camera module that is not inclined is transmitted to the image synthesizing unit.

11. The image processing method according to claim 9,
wherein step (d) is performed by calculating the difference between the preset reference coordinate value and the current position coordinate value detected by the position sensor to measure an angle (θx) at which a y-z plane is inclined based on an x axis, an angle (θy) at which an x-z plane is inclined based on a y axis, and an angle (θz) at which an x-y plane is inclined based on a z axis.

12. The image processing apparatus according to claim 11, wherein in step (e), correction values (x′, y′ and z′) are calculated according to the following Equation 1 in the case in which the inclined angle of the camera module measured by step (d) is θx:
$$[ \begin{matrix}{x}^{′} \\ {y}^{′} \\ {z}^{′}\end{matrix} ] = [ \begin{matrix}1 & 0 & 0 \\ 0 & cos θ & sin θ \\ 0 & - sin θ & cos θ\end{matrix} ] [ \begin{matrix}x \\ y \\ z\end{matrix} ] \qquad [ Equation 1 ]$$
correction values (x′, y′ and z′) are calculated according to the following Equation 2, in the case in which the inclined angle of the camera module measured by the measuring unit is θy:
$$[ \begin{matrix}{x}^{′} \\ {y}^{′} \\ {z}^{′}\end{matrix} ] = [ \begin{matrix}sin θ & 0 & cos θ \\ 0 & 1 & 0 \\ cos θ & 0 & - sin θ\end{matrix} ] [ \begin{matrix}x \\ y \\ z\end{matrix} ] \qquad [ Equation 2 ]$$
correction values (x′, y′ and z′) are calculated according to the following Equation 3 in the case in which the inclined angle of the camera module measured by the measuring unit is θz:
$$[ \begin{matrix}{x}^{′} \\ {y}^{′} \\ {z}^{′ }\end{matrix} ] = [ \begin{matrix}cos θ & sin θ & 0 \\ - sin θ & cos θ & 0 \\ 0 & 0 & 1\end{matrix} ] [ \begin{matrix}x \\ y \\ z\end{matrix} ] , \qquad [ Equation 3 ]$$
and
the position value of the image obtained by the inclined camera module is moved by the calculated correction values (x′, y′ and z′).

13. The image processing method according to claim 9, further comprising:
processing the omni-directional image generated in step (f) through the decoder so as to be displayed.
